(19) United States
(12) Patent Application Publication
(10) Pub. No.: US 2026/0136447 A1
(43) Pub. Date: May 14, 2026

(54) BOOT-UP LIGHTING SEQUENCE

(71) Applicant: HiViz Lighting, Inc., Hendersonville, NC (US)

(72) Inventor: Samuel T. Massa, Hendersonville, NC (US)

(73) Assignee: HiViz Lighting, Inc., Hendersonville, NC (US)

(21) Appl. No.: 19/387,079

(22) Filed: Nov. 12, 2025

Related U.S. Application Data
(60) Provisional application No. 63/719,496, filed on Nov. 12, 2024.

(51) Int. Cl. H05B 47/17; B60Q 1/52; B60Q 11/00; H05B 45/10; H05B 45/20; H05B 45/50; H05B 47/11; H05B 47/155; H05B 47/19; H05B 47/20

(52) U.S. Cl. CPC H05B 47/17; B60Q 1/52; B60Q 11/005; H05B 45/10; H05B 45/20; H05B 45/50; H05B 47/11; H05B 47/155; H05B 47/19; H05B 47/20

(57) ABSTRACT

An emergency system configured to execute a boot-up lighting sequency when power is applied. The boot-up may include a first light sequence wherein the plurality of light modules is illuminated in a first color in a first order, and a second light sequence wherein the plurality of light modules is illuminated in a second color in a second order. Further, a method of testing the operation of an emergency light system, including supplying power to the emergency light system, and executing a boot-up light sequence.

### CROSS REFERENCE TO RELATED APPLICATION

This application claims the benefit of U.S. Provisional Application No. 63/719496, filed Nov. 11, 2025, the entire disclosure of which is incorporated herein.

### BACKGROUND

In high end automobiles, some headlights with multiple optical elements can be controlled in such a way that, similar to the unlock park light flash, the headlights run through a sequence that is unique. Conventionally, this is done with pulse width modulation (PWM) controllable light emitting diode (LED) headlights with integrated daytime running lights (DRLs) and other circuits.

While the headlight market has this boot-up sequence functionality available, in fire apparatus and other emergency vehicles, often the vehicles are fleet apparatuses which do not have complex headlights or other accents.

Further, on a fire apparatus or ambulance, the operator is required to check the truck every day to ensure all equipment is working properly.

Accordingly, emergency light boot sequences that allow an operator to inspect the truck to be sure each module is working properly before relying on it in the event of an emergency, and which have aesthetic appeal to operators are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, disclosed herein is an emergency light bar configured to execute a boot-up lighting sequency when power is applied. In some embodiments, the emergency light bar includes a plurality of light modules. In some embodiments, the boot-up lighting sequence comprises lighting each light module of the plurality of light modules in a predetermined order.

In some embodiments, each light module of the plurality of light modules is configured to be controlled independent of another light module of the plurality of light modules.

In some embodiments, at least one light module of the plurality of light modules comprises a common optical element configured to emit red, green, blue, amber, and white light.

In some embodiments, the plurality of light modules is configured to emit a flash pattern.

In some embodiments, each light module of the plurality of light modules comprises two or more light elements.

In some embodiments, the emergency light bar further includes a first corner light module, configured to couple to the exoskeleton, and a second corner light module configured to couple to the exoskeleton.

In some embodiments, the emergency light bar further includes an exoskeleton configured to couple to the plurality of light modules, where when the first corner light module and the second corner light module are coupled to the exoskeleton, an opening is formed.

In some embodiments, the boot-up sequence includes a first light sequence wherein the plurality of light modules is illuminated in a first color in a first order, and a second light sequence wherein the plurality of light modules is illuminated in a second color in a second order.

In some embodiments, the first order is a lighting pattern towards a central line of the emergency light bar. In some embodiments, the second order is a lighting pattern away from a central line of the emergency light bar.

In some embodiments, the plurality of light modules is illuminated with a ramping light pattern.

In some embodiments, a first corner module and a second corner module are included in the first light sequence, the second light sequence, or a combination thereof. In some embodiments, the boot-up sequence further includes one or more flashes of a corner color emitted by a first corner module and a second corner module.

In some embodiments, the one or more flashes of the first corner light module and the second corner light module occur substantially simultaneously.

In another aspect, disclosed herein is a method of testing the operation of an emergency light bar, including supplying power to the emergency light bar, and executing a boot-up light sequence.

In some embodiments, executing the boot-up light sequence includes illuminating each module of a plurality of light modules on the emergency light bar. In some embodiments, executing the boot-up light sequence further includes illuminating a first corner module and a second corner module of the emergency light bar.

In some embodiments, executing the boot-up light sequence includes flashing the first corner module and the second corner modules with a corner color, illuminating the first corner module, the second corner module, and the plurality of light modules towards a central line of the emergency light bar with a first color; and illuminating the first corner module, the second corner module, and the plurality of light modules away from the central line of the emergency light bar with a second color

In some embodiments, illuminating the first corner module, the second corner module, and the plurality of light modules include fading each light module in, and fading each light module out.

In some embodiments, flashing the first corner module and the second corner module includes flashing the first corner module and the second module twice, substantially simultaneously.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1D are example lighting system, in accordance with the present technology;

FIGS. 2A-2C show various example lighting systems 100 having a plurality of light modules, in accordance with the present technology.

FIG. 3 is an example lighting system, in accordance with the present technology.

FIGS. 4A-4B shows frontside perspectives of a lighting element, in accordance with the present technology.

FIGS. 5A-5G are an example boot-up sequence, in accordance with the present technology.

FIGS. 6A-6E are example ramping patterns, in accordance with the present technology.

FIG. 7 is an example architecture of a lighting system, in accordance with the present technology.

FIG. 8 is an example method of using a lighting system, in accordance with the present technology.

### DETAILED DESCRIPTION

Disclosed herein are systems and methods of using emergency light bars and lighting systems configured to execute boot-up sequences. In some embodiments, the method disclosed herein includes turning a battery switch of the emergency vehicle on, and observing the boot sequence to make sure every module comes on as expected. Once the boot sequence is executed, the operator can then go save lives.

In some embodiments, when a warning lightbar (or emergency lightbar), whole light system, auxiliary light system, or any lighting system for emergency vehicles receives power (from the vehicle or otherwise), the lighting system may automatically turn on various modules in a sequential manner.

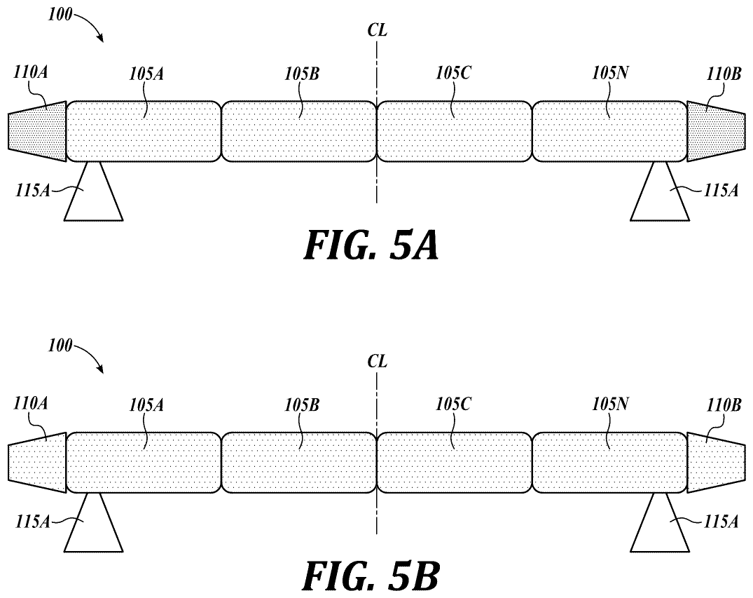

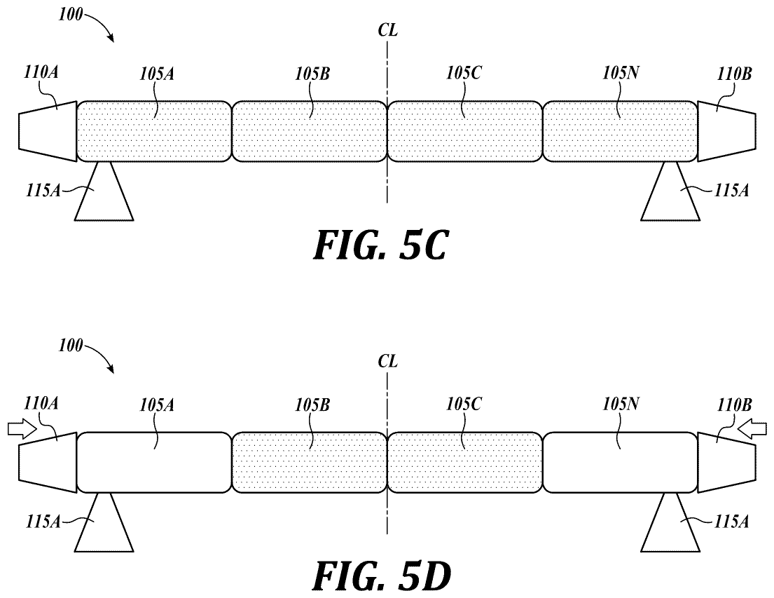

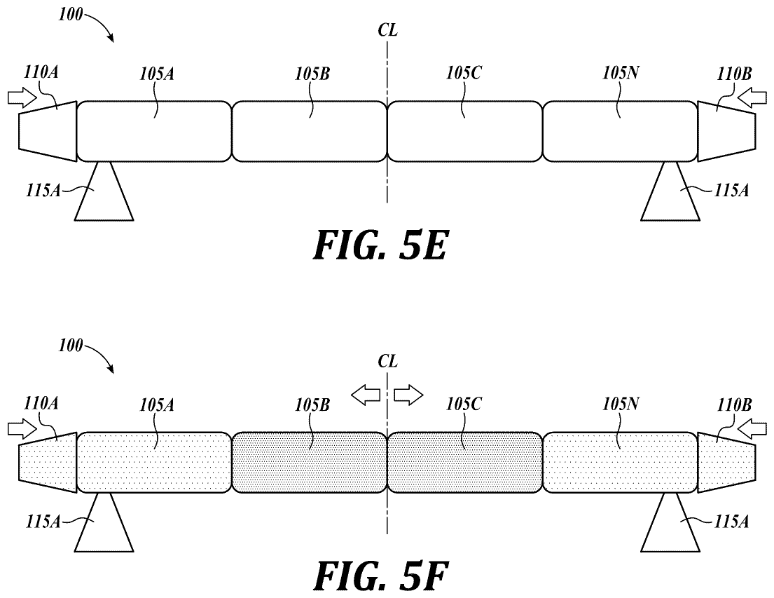

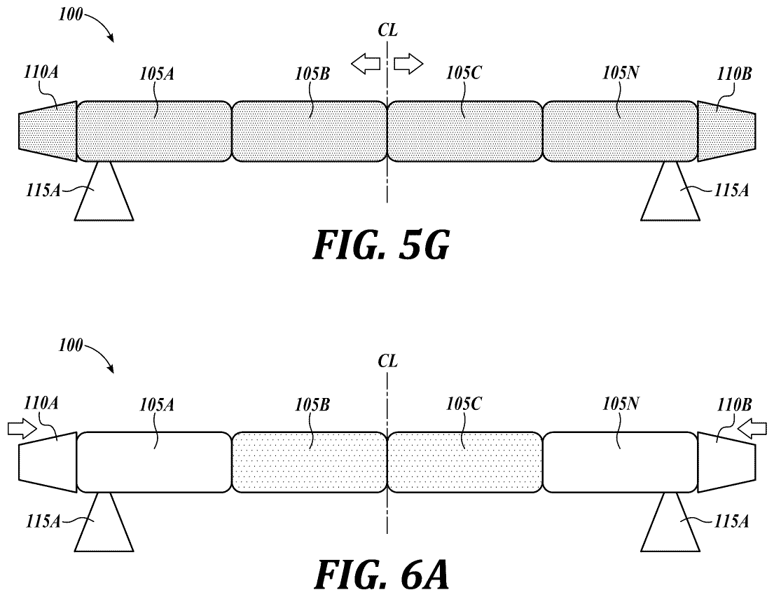

In one example, the boot-up sequence may include two flashes from the corner modules in the color amber. In some embodiments, each lighting module of a plurality of lighting modules may fade in in the color white. In some embodiments each lighting module of a plurality of lighting modules may fade in in the color red. This lighting sequence is illustrated in FIGS. 5A-5G.

In some embodiments, any time power is connected to the lighting system, without needing any user input, it executes a sequential function that illuminates multiple circuits/modules on the fixture.

In some embodiments, the boot-up lighting sequence is not a looping pattern, i.e., it executes a single time and then turns off. In some embodiments, it is not necessary to re-execute the boot-up lighting sequence until the fixture is power cycled.

In some embodiments, the boot-up lighting sequence is executed in amber, white, and red colored light.

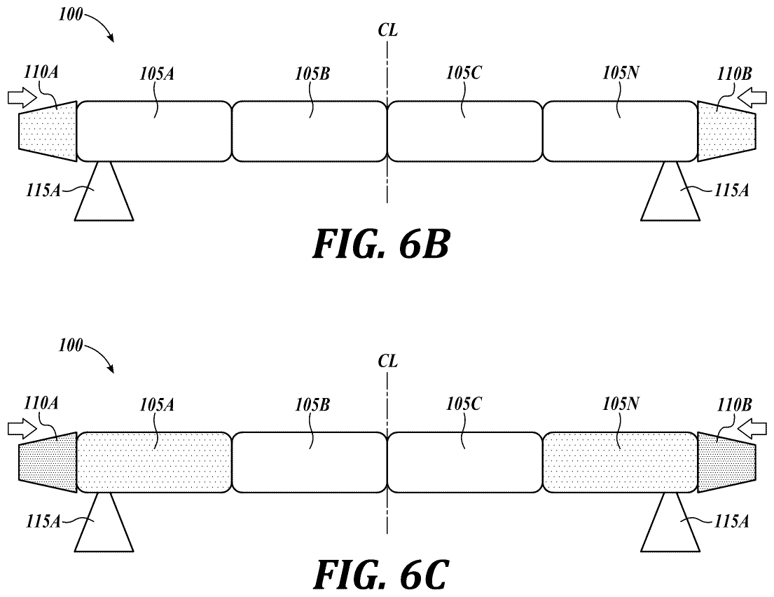

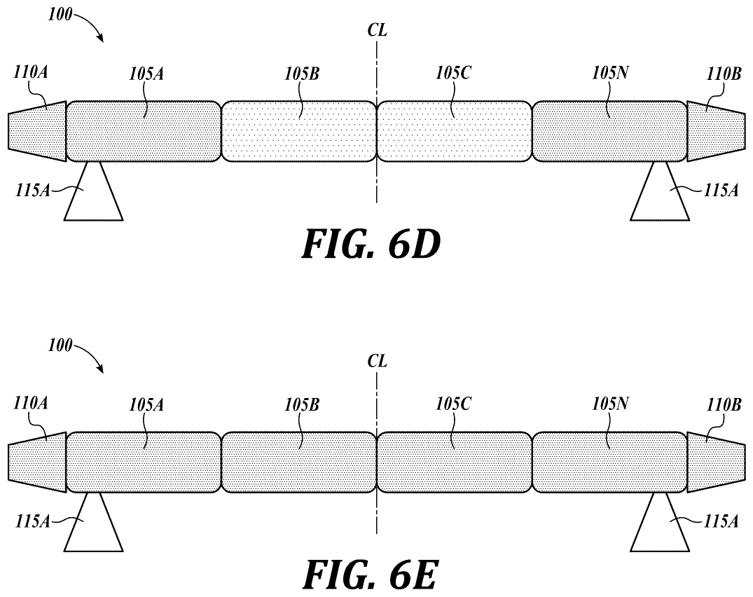

In some embodiments, the boot-up lighting sequence takes less than 15 seconds to complete. In some embodiments, the boot-up lighting sequence includes ramping patterns as shown in FIGS. 6A-6E. In some embodiments, the boot-up lighting sequence may turned off or disabled.

In some embodiments, the boot-up lighting sequence further includes a timer that prevents the boot-up lighting sequence from occurring more often or too frequently. For example, if an emergency vehicle arrives on a scene, an operator shuts the car off, then immediately turns it back on, the timer may prevent the boot-up lighting sequence from occurring unless the timer has elapsed. In some embodiments, the timer is set for a predetermined time, such as 1 minute, 10 minutes, or 30 minutes. The timer may further allow for power-saving.

In some embodiments, a switch, such as on the lighting system or the emergency vehicle may be actuated to begin the boot-up lighting sequence.

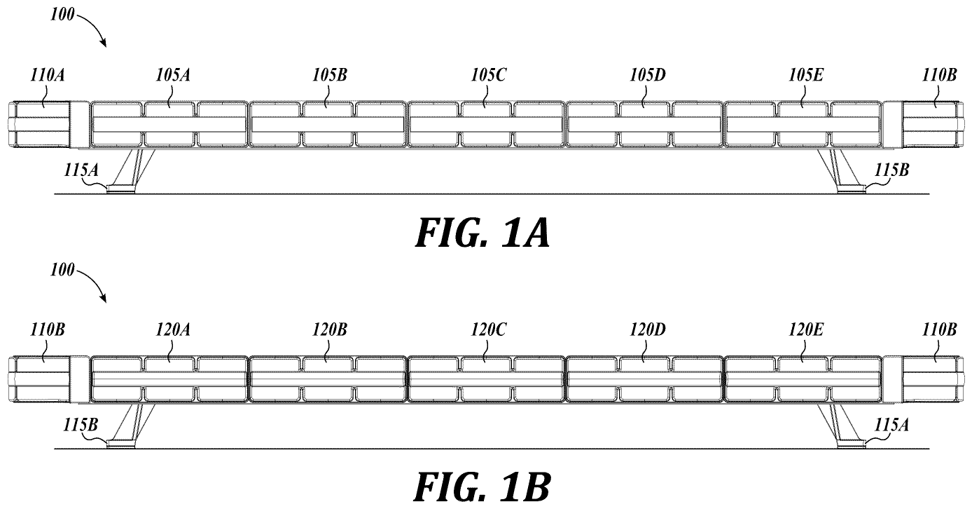

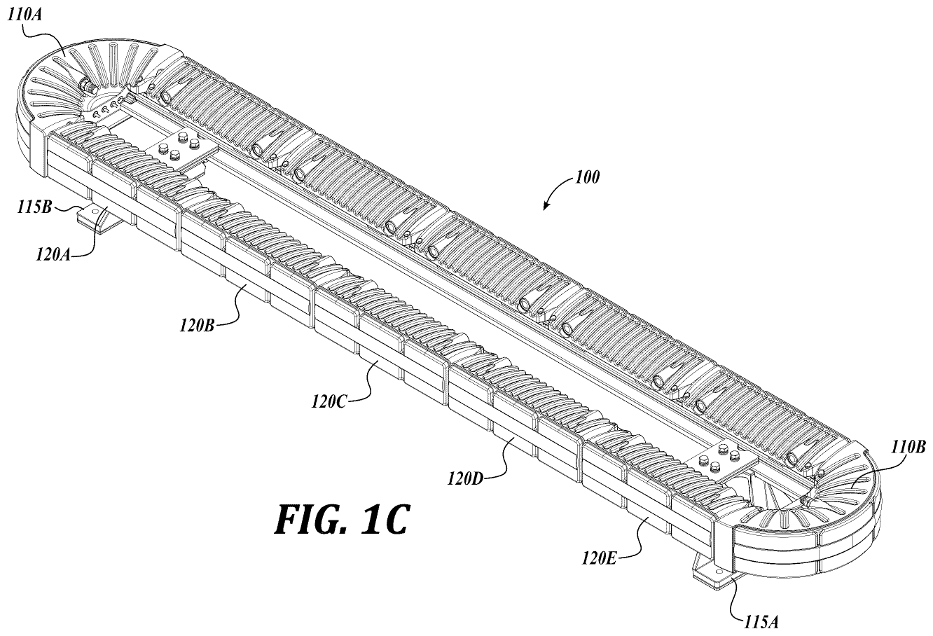

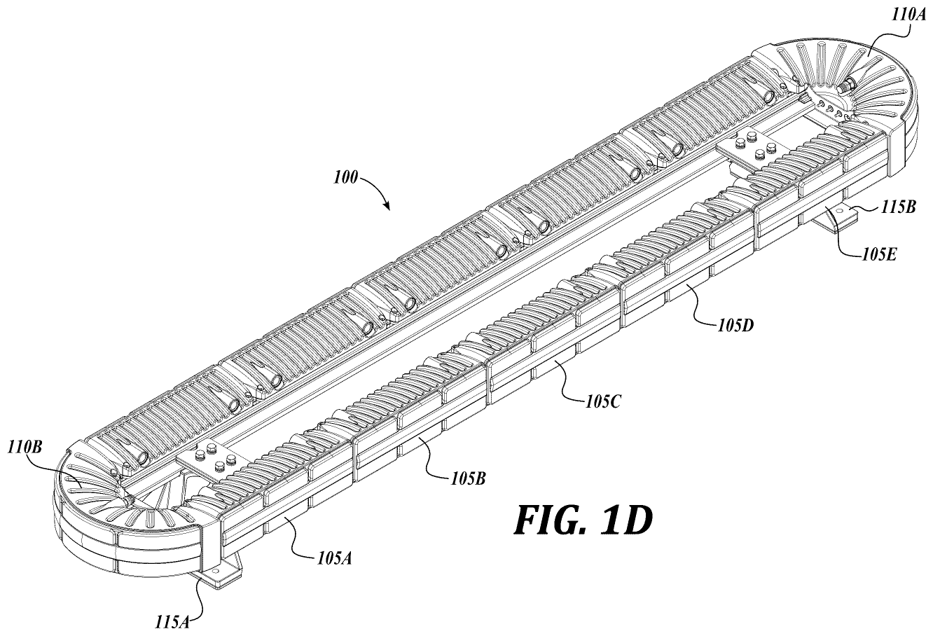

FIGS. 1A-1D are example lighting systems 100 ((also referred to herein as an “emergency lightbar”), in accordance with the present technology.

FIGS. 1A-1D shows front, rear, top front, and top rear perspectives of the lighting system 100, respectively. In some embodiments, the lighting system 100 includes an exoskeleton. In some embodiments, the exoskeleton is a single, extruded bar (or “extrusion”). In some embodiments, the exoskeleton is a curved bar. In some embodiments, the exoskeleton includes a first bar and a second bar. In some embodiments, the exoskeleton is a track. In some embodiments, the exoskeleton includes any number of bars, including three, four, or five bars. The exoskeleton may take any number of forms capable of allowing a plurality of light modules, as described herein, to connect to the exoskeleton. In some embodiments, such as when there are two bars, the first bar and the second bar are of equal size. In some embodiments, the lighting system 100 does not include an exoskeleton.

In some embodiments, the lighting system 100 also includes a plurality of light modules 105A, 105B, 105C, 105D, 105E. In some embodiments, the plurality of light modules 105A, 105B, 105C, 105D, 105E are configured to couple to the exoskeleton. In some embodiments, the plurality of light modules 105A, 105B, 105C, 105D, 105E are free-standing, that it, not coupled to an exoskeleton. In some embodiments, the plurality of light modules 105A, 105B, 105C, 105D, 105E includes lights of the vehicle, such as headlights, taillights, and the like. When the exoskeleton has two bars, the plurality of light modules 105A, 105B, 105C, 105D, 105E may connect to either the first bar or the second bar of the exoskeleton. In some embodiments, the lighting system further includes a first corner light module 110A, configured to couple a first side of the first bar and a first side of the second bar together, and a second corner light module 110B configured to couple a second side of the first bar and a second side of the second bar. In some embodiments, the first corner light module 110A and the second corner light module 110B are coupled to the exoskeleton, an opening is formed between the first bar and the second bar. In some embodiments, the lighting system takes the shape of a “donut,” such as shown in FIG. 1C. In some embodiments, the first corner light module 110A and the second corner light module 110B are shaped like three dimensional ellipses, as shown in FIG. 1C.

In some embodiments, the light modules and the corner light modules are configured to emit a flash pattern. In some embodiments, the light modules 105A, 105B, 105C, 105D, 105E and the corner light modules 110A, 110B are each controlled separately. As used herein, it should be understood that in some embodiments, each light module of the light modules 105A, 105B, 105C, 105D, 105E includes a separate controller. In other embodiments, a single controller controls all light modules 105A, 105B, 105C, 105D, 105E and the corner light modules 110A, 110B. In such embodiments, the controller can direct each of the light modules 105A, 105B, 105C, 105D, 105E and/or the corner light modules 110A, 110B independently, or in a group. For example, the controller may control some of the light modules, such as 105A and 105C as a group. One skilled in the art should understand that any number of the light modules 105A, 105B, 105C, 105D, 105E and/or the corner light modules 110A, 110B can be combined into one or more groups, which can be controlled together. In some embodiments, all the light modules 105A, 105B, 105C, 105D, 105E and the corner light modules 110A, 110B are controlled together.

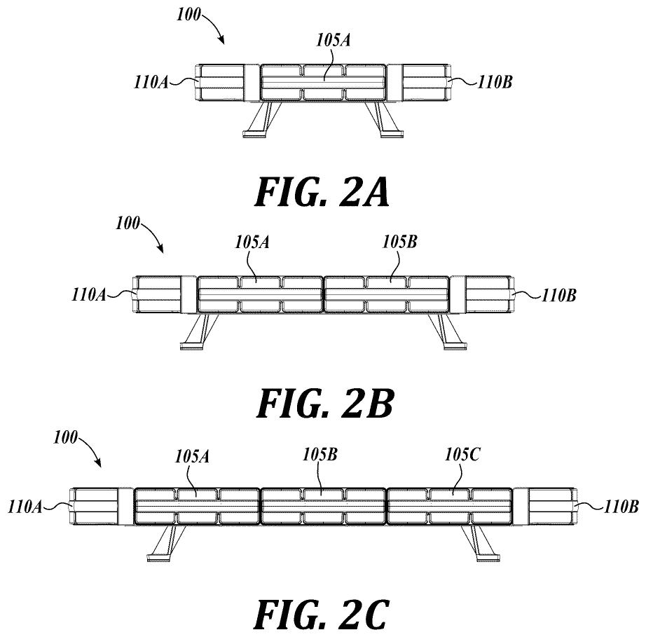

In some embodiments, the lighting system 100 includes one or more blank modules 120A, 120B, 120C, 120D, 120E. In some embodiments, the blank modules 120A, 120B, 120C, 120D, 120E face towards a back end of a vehicle or a back of the lighting system 100 as shown in FIG. 1B. In some embodiments, the plurality of light modules 105A, 105B, 105C, 105D, 105E face towards a front end of a vehicle, or a front of the lighting system 100, as shown in FIG. 1A. It should be understood that while five light modules 105A, 105B, 105C, 105D, 105E and five blank modules 120A, 120B, 120C, 120D, 120E are illustrated, any number of light modules and blank modules may be coupled to the exoskeleton, as shown in FIGS. 2A-2F. The number of light modules and the number of blank modules may not be equal. The lighting system is modular, so any number of light modules and blank modules could be coupled to the exoskeleton in any position, including alternating blank modules and light modules, and the like. In some embodiments, the blank modules may contain one or more electrical components, as shown herein.

FIGS. 2A-2C show various example lighting systems 100 having a plurality of light modules (such as 105A, 105B, 105C, 105D, 105E in FIG. 1A), in accordance with the present technology.

In some embodiments, each light module of the plurality of light modules is configured to be controlled independently. In some embodiments, the plurality of light modules is configured to emit a flash pattern. In some embodiments, the exoskeleton may be any length. In some embodiments, the first bar and/or the second bar may be any length. In this manner, any number of light modules (or blank modules) can be coupled with the two bars to form the lighting system as shown in FIG. 1.

For example, the plurality of light modules may include a single light module (FIG. 2A), two light modules (FIG. 2B), or three light modules (FIG. 2C). In some embodiments, the lighting system is attached to a vehicle, as described herein. By allowing for any number of light modules in the plurality of light modules, the lighting system can be adjusted to fit in any location on any sort of vehicle. In some embodiments, the vehicle is a car, a truck, a plane, a train, or the like. In some embodiments, the vehicle is an emergency vehicle. In some embodiments, the vehicle is a firetruck.

In some embodiments, the lighting system includes only two corner modules 110 coupled to one another to form a “light beacon” such as described in U.S. application Ser. No. 18/639229, the entire disclosure of which is hereby incorporated by reference.

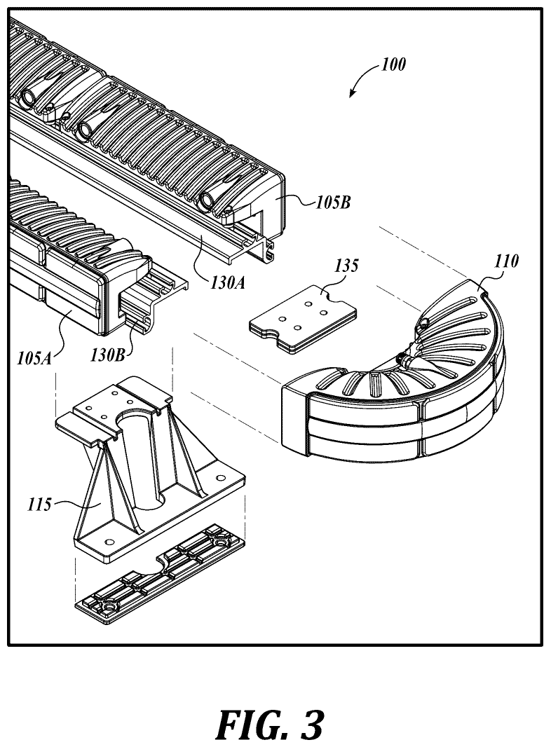

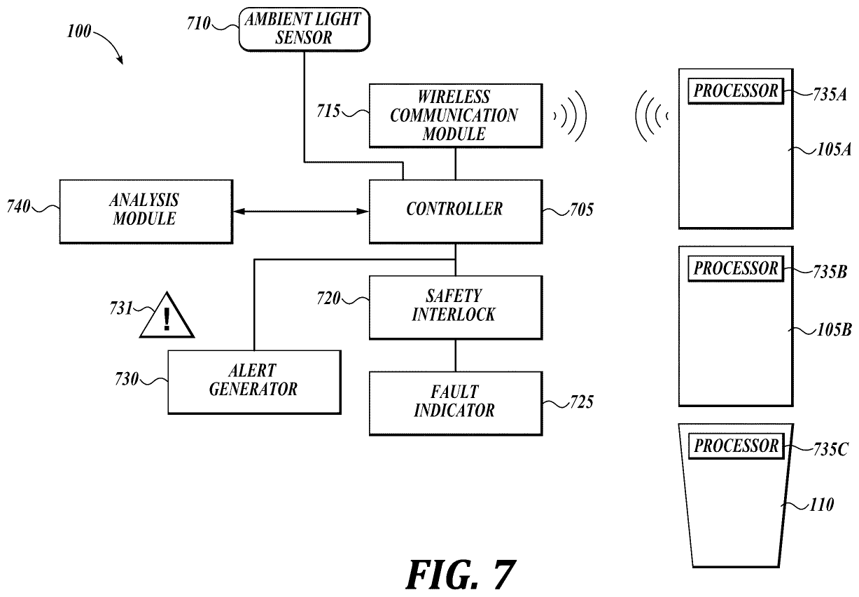

FIG. 3 is an example lighting system, in accordance with the present technology. In some embodiments, the light corner modules 110 are configured to couple the first bar 130A and the second bar 130B of the exoskeleton together. As shown in FIG. 7, the corner light modules 110 may have a female connection configured to couple to the first bar 130A and the second bar 130B. In some embodiments, the interconnects (such as interconnects 107, 127) of the blank modules, light modules 105A, 105B, or the light corner modules may work to electrically couple the light corner module 110 to adjacent light modules 105A, 105B, blank modules, or light modules and blank modules.

In some embodiments, the attachment feet 115A, 115B couple to the exoskeleton with one or more connections 135. In some embodiments, the connections 135 are clamps, grooves, or the like. In some embodiments, the attachment feet 115A, 115B may slide along the two bars 130A, 130B to adjust the placement of the attachment feet. In this manner, the lighting system can be modified to attach to any size vehicle or in any location of the vehicle, regardless of the size of the two bars of the exoskeleton.

In some embodiments, at least one light module of the plurality of light modules comprises a common optical element configured to emit red, green, blue, amber, and white light. In some embodiments, the common optical element is a five color LED circuit. In some embodiments, the five color LED circuit uses five single independent LEDs. In some embodiments, the five color LED circuit includes four pixels and a 5th primary color. In some embodiments, the five colors are selected from blue, red, amber, green, and white color light.

In some embodiments, every light module of the plurality of light modules is capable of emitting red, green, blue, amber, and white light. In some embodiments, the red, green, blue, amber, and white light are colors that are compliant with the Society of Automotive Engineers (SAE) standard J 578-2020. In order to comply with SAE standards, the colored light may be chromatically accurate. In some embodiments, in order to comply with SAE standards, individual LEDs are used to emit chromatically accurate colored light.

Conventionally, emergency lights may have light modules which can be disposed adjacent to one another to create a light bar that emits five colors. In some conventional emergency lighting systems, the modules may be able to emit three colors, or rarely, four colors. For example, one light module may be able to emit red, blue, or white light.

In contrast, the lighting system 100 disclosed herein is capable of emitting any color light from any light module of the plurality of light modules. In some embodiments, each light module of the plurality of light modules is capable of emitting red, green, blue, amber, and white light. Further, the plurality of light modules may also emit a combination of any of red, green, blue, amber, and white light. In some embodiments, the plurality of light modules are further configured to emit infrared (IR) light.

In some embodiments, when in command mode, one or more additional lights, separate from the lighting system 100 also emit a steady green light. As used herein, the term “additional lights” includes lights of a vehicle and standalone lights separate from lighting system 100.

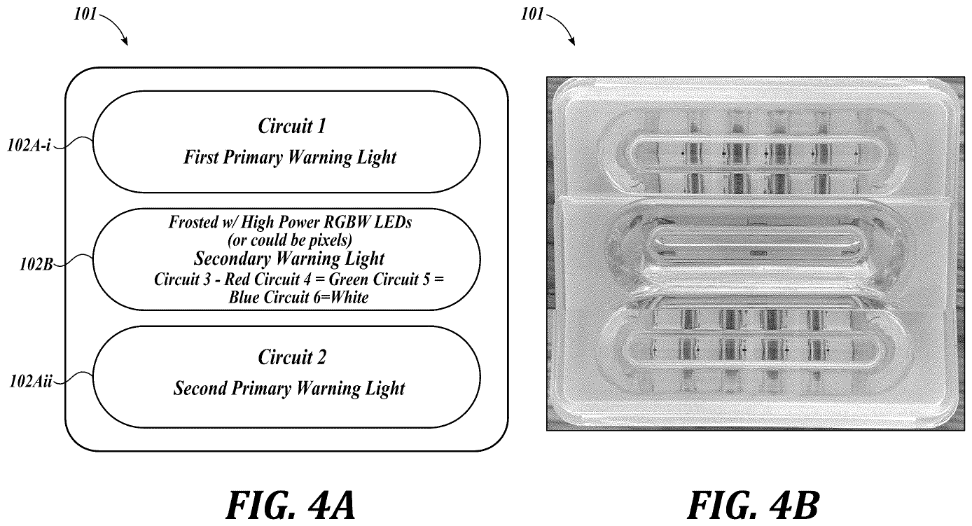

FIG. 4A-4B shows frontside perspectives of a lighting element 101, in accordance with the present technology. In some embodiments, each light module includes one or more lighting elements 101. In some embodiments, each light module includes three lighting elements 101. As shown in FIG. 4A, in some embodiments, each light element 101 includes a first primary warning light 102A-i, a second primary warning light 102A-ii, and a secondary warning light 102B disposed between the first primary warning light 102A-i and the second primary warning light 102A-ii. In some embodiments, each light element includes a cover (as shown in FIG. 3). In some embodiments, a portion of the cover that protects the secondary warning light (such as 103) is a milky or frosted material. In some embodiments, the milky or frosted material diffuses the colored light emitted from the secondary warning light.

In some embodiments, the lighting system (such as lighting system 100) is configured to execute a boot-up sequence when power is applied. As used herein, “applying power” includes turning on a vehicle (such as emergency vehicle) that the lighting system is coupled to. In some embodiments, the boot-up sequence includes illuminating the plurality of light modules (and/or the corner light modules) in a predetermined order or pattern. In this manner, each light module of the emergency light bar may be tested. An observer may determine if the light bar is operational by watching the boot-up sequence. Further, if one or more light modules of the plurality of light modules does not illuminate as expected, a user of the system may be able to easily tell which module needs to be repaired/replaced. In some embodiments, the boot-up sequence is executed in a predetermined amount of time, such as 30 seconds, 15 seconds, or 10 seconds. In some embodiments, the boot-up sequence occurs only when the emergency vehicle is turned on, or the emergency light bar is power cycled. In some embodiments, the boot-up sequence may include a timer, which prevents the boot-up sequence from executing the boot-up sequence in a duplicative manner. In such embodiments, the boot-up sequence may not be executed if a vehicle is turned off for a predetermined amount of time, such as less than 1 minute, less than 5 minutes, or less than 30 minutes.

Described below are example boot-up sequences. The boot-up sequences shown are merely exemplary and should not be considered limiting.

In some embodiments, the plurality of light modules are independent individual complete modules and computers (nodes) on a network. Accordingly, the plurality of light modules is configured to “know” where each light module is in space. Similarly, the plurality of light modules is configured to “know” how many other modules (including light modules) are in the system in order to calculate and execute a boot sequence that is aesthetically appealing, such as by selecting colors, orders of illumination, amounts of light modules and/or corner modules to illuminate at a predetermined time in the sequence, pattern, or the like.

In some embodiments, the emergency lighting system is configured to boot up, calculate the number of modules (such as light modules and corner modules) in the emergency light bar (which may include querying the network, listening for acknowledgments from the one or more light modules and/or corner modules, and/or determining a total number of identifications (IDs) reporting). The emergency light bar may then send commands to execute and/or illuminate specific modules (such as light modules and corner modules) in a predetermined order.

On first boot-up, the emergency light bar may run the sequence of querying. In some embodiments, the emergency light bar may then store the determined configuration to persistent memory. In this manner, on a second or subsequent boot-up, the emergency light bar may reference that persistent memory to know how many modules are on the network. In some embodiments, this occurs automatically.

FIGS. 5A-5G are an example boot-up sequence, in accordance with the present technology. Light modules 105A, 105B, 105C . . . 105N (and/or corner modules 110A, 110B) that are gray are considered “OFF” (i.e., not emitting light). While amber, white, and red light are shown in FIGS. 5A-5G, it should be understood that the emergency light bar may emit any color of light including red, green, blue, amber, white, or a combination thereof.

Optionally, in FIGS. 5A-5B, the corner light modules 110A, 110B flash a corner color of light. While FIGS. 5A-5B are in black and white, it should be understood that in FIG. 5A, the corner modules 110A, 110B are “on” (i.e., emitting a color of light).

While a single flash is illustrated in FIGS. 5A-5B, it should be understood that the corner modules 110A, 110B may flash any number of times. In some embodiments, the corner color is amber. In some embodiments, the corner color is red, green, blue, amber, white, or a combination thereof.

In some embodiments, the one or more flashes of the first corner light module 110A and the second corner light module 110B occur substantially simultaneously.

In one example, the boot-up lighting sequence includes a first light sequence wherein the plurality of light modules is illuminated in a first color in a first order. FIGS. 5C-5E are an example of a first light sequence.

In some embodiments, the first order is a lighting pattern towards a central line CL of the emergency light bar 100. In some embodiments, the first color is white. In some embodiments, the first color is red, green, blue, amber, white, or a combination thereof. In some embodiments, the first lighting sequence includes emitting a ramping or breathing light from each light module of the plurality of light modules 105A, 105B, 105C . . . 105N. An example of the ramping/breathing light sequence is shown in FIGS. 6A-6E. While the first order is shown as a lighting pattern towards the central line CL of the emergency light bar 100, it should be understood that in some embodiments, the first order is a lighting pattern away from the central line CL (as shown in FIGS. 5F-5G).

In some embodiments, the boot-up lighting sequence further includes a second light sequence wherein the plurality of light modules is illuminated in a second color in a second order. FIGS. 5F-5G are an example of a second light sequence.

In some embodiments, the second order is a lighting pattern away from a central line CL of the emergency light bar 100. In some embodiments, the second color is red. In some embodiments, the second color is red, green, blue, amber, white, or a combination thereof. In some embodiments, the second lighting sequence includes emitting a ramping or breathing light from each light module of the plurality of light modules 105A, 105B, 105C . . . 105N. An example of the ramping/breathing light sequence is shown in FIGS. 6A-6E. While the second order is shown as a lighting pattern away from the central line CL of the emergency light bar 100, it should be understood that in some embodiments, the second order is a lighting pattern towards the central line CL (as shown in FIGS. 5C-5E).

In some embodiments, the first corner module 110A and the second corner module 110B are included in the first light sequence, the second light sequence, or a combination thereof. FIGS. 6A-6E are example ramping patterns, in accordance with the present technology.

In some embodiments, the plurality of light modules is illuminated with a ramping light pattern. An example of the ramping light pattern is shown in FIGS. 6A-6E.

As shown above, as used herein, a ramping (or “breathing”) pattern includes fading in the illumination of the plurality of light modules 105A, 105B, 105C . . . 105N (and/or the corner modules 110A, 110B), and then fading out the illumination of the plurality of light modules 105A, 105B, 105C . . . 105N (and/or the corner modules 110A, 110B). While the ramping pattern is shown as illuminating the plurality of light modules 105A, 105B, 105C . . . 105N (and/or the corner modules 110A, 110B) towards the central line CL, it should be understood that in some embodiments, the ramping pattern is away from the central line CL as shown in FIGS. 5F-5G. In some embodiments, both the first sequence and second sequence include a ramping pattern.

FIG. 7 is an example architecture of a lighting system 100, in accordance with the present technology. FIG. 7 should be understood as merely exemplary, and one skilled in the art will recognize that components illustrated may be moved, changed, or omitted.

In some embodiments, the lighting system 100 includes a controller 705, configured to communicate with a number of components through a wired or wireless connection. In some embodiments, the controller 705 is configured to provide instructions to a number of components. These components may include, but are not limited to, an ambient light sensor 710, a wireless communication module 715, a safety interlock 720, a fault indicator 725, an alert generator 730, and/or an analysis module 740.

In some embodiments, the lighting system 100 includes an ambient light sensor 710. In some embodiments, the ambient light sensor 710 is configured for automatic dimming or adaptive sequencing. In some embodiments, the ambient light sensor may automatically adjust a light intensity of the one or more light modules 105A, 105B and/or corner light modules 110. In this manner, the ambient light sensor 710 may adjust the visibility of the lighting system in various lighting conditions (e.g., night, dawn, bright sunlight, etc.).

In some embodiments, the lighting system 100 further includes a wireless communication module 715. The wireless communication module 715 may communicate with light modules 105A, 105B and/or the corner light modules 110. In some embodiments, the wireless communication module 715 establishes a wireless connection through Bluetooth, Bluetooth Low Energy (BLE), Zigbee, Wi-Fi, or the like.

In some embodiments, each light module 105A, 105B and the corner light modules 110 each include a light module processor 735A, 735B, 735C, configured to receive instructions from the controller 705 through the wireless communication module 715. In some embodiments, each light module processor 735A, 735B, 735C, may include an ambient light sensor 710, a wireless communication module 715, a safety interlock 720, a fault indicator 725, an alert generator 730, and/or an analysis module 740. In such embodiments, the light module processors 735A, 735B, 735C, operate as the controller 705.

In some embodiments, the lighting system 100 includes a safety interlock 720. In some embodiments, if a light module 105A, 105B or corner light module 110 is determined as non-operational, the safety interlock 720 may communicate with the vehicle to put the vehicle into park, deploy the brakes of the vehicle, or otherwise prevent the vehicle from being driven until the issue is resolved.

In some embodiments, the lighting system 100 includes a fault indicator 725. In some embodiments, the fault indicator 725 is connected to the vehicle, and may display an alert that a fault has been detected in a light module 105A, 105B and/or corner light module 110. In some embodiments, the fault indicator 725 displays an alert in combination with the safety interlock 720 being deployed. In some embodiments, the fault indicator 725 displays the fault on a dashboard of the vehicle.

In some embodiments, the lighting system 100 includes an alert generator 730. In some embodiments, the alert generator 730 issues an alert 731 when a fault is detected, when a light module 105A, 105B and/or corner light module 110 is determined non-operational, when a light module 105A, 105B and/or corner light module 110 should be replaced, or a combination thereof. In some embodiments, the alert generator 730 is configured to send the alert 731 to a dashboard of the vehicle, a smart device, a computer, a tablet, a cellphone, or a combination thereof. In some embodiments, the alert 731 is a visual alert, such as a notification, text message, a dashboard status light, or the like. In some embodiments, the alert 731 is an auditory alert, such as a chime, alarm, or the like. In some embodiments, the alert 731 is a haptic alert, such as a vibration. In some embodiments, the alert may be combination of a visual alert, auditory alert, and/or haptic alert.

In some embodiments, the lighting system 100 includes an analysis module 740. In some embodiments, the analysis module 740 is configured for receiving a light level from the ambient light sensor 710, calculate a light output of each light module 105A, 105B, and/or corner light module 110, and confirm compliance with National Fire Protection Association (NFPA) zone-coverage requirements. In some embodiments, the analysis module 740 may calculate a light output of a light zone of the lightbar, for example, only a subsection of the light modules 105A, 105B and/or corner light modules 110. FIG. 7 shows an example “zone” made up of two light modules 105A, 105B and a corner light module 110A. It should be understood that a zone could be any portion of the lightbar, including one or more light modules and one or more corner light modules. In some embodiments, the analysis module 740 may calculate light levels for a variety of purposes including determining if all light modules are functional, if all light modules are emitting enough light based on the lighting condition from the ambient light sensor 710, or a combination thereof.

In operation, the analysis module 740 is configured to receive an ambient light measurement from the ambient light sensor 710, receive a module light measurement at least a portion of the plurality of light modules 105A, 105B, calculate a light output of the at least a portion of the plurality of light modules based on the ambient light measurement and the module light measurement, and determine if the light output complies with NFPA requirements.

In some embodiments, the lighting system 100 is configured to test the operation of the emergency lighting system. In some embodiments, this includes supplying power to an emergency lightbar of the emergency lighting system 100 and executing a boot-up light sequence as described herein.

In some embodiments, the lighting system 100 is further configured to determine an operability of the lighting system 100. In some embodiments, this includes activating a pre-trip inspection mode as described herein. In some embodiments, the pre-trip inspection mode includes illuminating one or more light modules 105A, 105B of the plurality of light modules 105A, 105B in a walk-around path sequence, calculating a light output of the one or more light modules 105A, 105B, determining if the light output complies with a lighting threshold, and issuing an alert when the light output does not comply with the lighting threshold.

In some embodiments, the lighting threshold is based on NFPA standards. In some embodiments, the pre-trip inspection mode further includes engaging the safety interlock 420 when the light output does not comply with the lighting threshold.

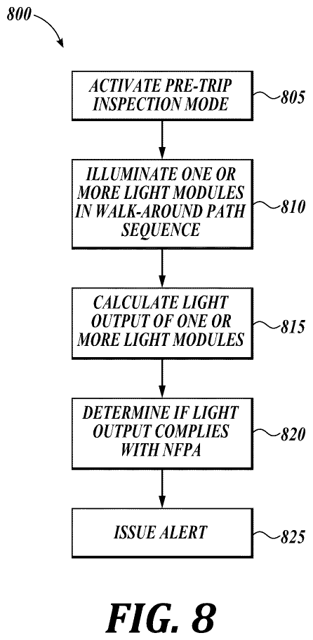

FIG. 8 is an example method 800 of using a lighting system, in accordance with the present technology. In some embodiments, the lighting system may operate in a pre-trip inspection mode for a vehicle's full warning-light system (including a lightbar).

In some embodiments, the method 800 may be carried out with a lighting system (such as lighting system 100). In some embodiments, the lighting system includes a plurality of light modules (such as light modules 105A, 105B, 105C . . . 105N) and/or corner light modules (such as corner light modules 110A, 110B). In some embodiments, the lighting system may include a controller (such as controller 705), an ambient light sensor (such as ambient light sensor 710), a wireless communication module (such as wireless communication module 715), a safety interlock (such as safety interlock 720), a fault indicator (such as a fault indicator 725), an alert generator (such as alert generator 730), and/or an analysis module (such as analysis module 740).

In block 805, the pre-trip inspection mode may be activated. In some embodiments, the pre-trip inspection mode may be activated with a smart device such as a computer, tablet, or cellphone. In some embodiments, the pre-trip inspection mode may be activated with a manual input, such as a switch on the vehicle's dashboard, a remote controller, or the like.

In block 810, one or more light modules (of both the lightbar and the vehicle generally) are illuminated in a walk-around path sequence. As used herein, the term light modules may refer to the light modules of the lightbar, and lights of the vehicle including headlights, taillights, sirens configured to emit light, and the like. Further, a walk-around path sequence may start at a position on the vehicle and move around the vehicle until returning to the same position. For example, a walk-around path sequence might be a front of the vehicle, a curbside of the vehicle, a rear of the vehicle, a roadside of the vehicle, and a roof.) In some embodiments, the walk-around path sequence starts with the lights at the position of the vehicle, with a timed dwell period that allows an operator to confirm functionality before moving around the vehicle. In some embodiments, the light modules may emit a reduced or pulsed light intensity to avoid glare and excessive noise. In some embodiments, the ambient light sensor may automatically adjust light intensity during the inspection or start-up sequence to maintain appropriate visibility in varying lighting conditions (e.g., night, dawn, bright sunlight). In some embodiments, the lighting system may send discrete signals to individual lights or zones as part of the pre-trip inspection process, enabling verification of proper function and communication integrity for each light module. In some embodiments, the lighting system may do this with the controller and/or wireless communication module. In some embodiments, lights may dim or turn off after being inspected by an operator.

In block 815, the output of one or more of the light modules is calculated. In some embodiments, the analysis module may perform this calculation. In some embodiments, the analysis module is configured for receiving a light level from the ambient light sensor and calculating a light output of each light module. In some embodiments, the analysis module may calculate a light output of a light zone of the lightbar, for example, only a subsection of the light modules and/or corner light modules. It should be understood that a zone could be any portion of the lightbar, including one or more light modules and one or more corner light modules. In some embodiments, the analysis module may calculate light levels for a variety of purposes including determining if all light modules are functional, if all light modules are emitting enough light based on the lighting condition from the ambient light sensor, or a combination thereof.

In block 820, the analysis module may determine if a light output complies with National Fire Protection Association (NFPA) requirements. In some embodiments, the light output may be determined on a light module by light module basis, or in a number of zones, as described herein.

In block 825, an alert (such as alert 731) may be issued. In some embodiments, the alert may be that the inspection is complete, that a fault was detected, that one or more light modules are non-operational, that one or more light modules comply with NFPA requirements, or the like. In some embodiments, the alert is a visual alert, such as a notification, text message, a dashboard status light, or the like. In some embodiments, the alert is an auditory alert, such as a chime, alarm, or the like. In some embodiments, the alert is a haptic alert, such as a vibration. In some embodiments, the alert may be combination of a visual alert, auditory alert, and/or haptic alert. In some embodiments, no alert is issued.

It should be understood that method 800 should be interpreted as merely representative. In some embodiments, process blocks of method 800 may be performed simultaneously, sequentially, in a different order, or even omitted, without departing from the scope of this disclosure.

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

What is claimed is:

1. A lighting system for an emergency vehicle comprising:
an emergency lightbar;
a plurality of light modules, wherein at least a portion of the plurality of light modules is on the emergency lightbar;
a controller configured to execute a boot-up lighting sequency when power is applied, wherein the boot-up lighting sequence comprises lighting each light module of the plurality of light modules in a predetermined order.

2. The lighting system of claim 1, wherein each light module of the plurality of light modules is configured to be controlled independent of another light module of the plurality of light modules.

3. The lighting system of claim 1, wherein at least one light module of the plurality of light modules comprises a common optical element configured to emit red, green, blue, amber, and white light.

4. The lighting system of claim 1, wherein the lightbar further comprises:
a first corner light module, and
a second corner light module.

5. The lighting system of claim 4, wherein the light bar further comprises an exoskeleton configured to couple to the plurality of light modules, wherein when the first corner light module and the second corner light module are coupled to the exoskeleton, an opening is formed.

6. The lighting system of claim 1, wherein the boot-up sequence comprises:
a first light sequence wherein the plurality of light modules is illuminated in a first color in a first order; and
a second light sequence wherein the plurality of light modules is illuminated in a second color in a second order.

7. The lighting system of claim 6, wherein the first order is a lighting pattern towards a central line of the emergency lightbar.

8. The lighting system of claim 6, wherein the second order is a lighting pattern away from a central line of the emergency lightbar.

9. The lighting system of claim 6, wherein the plurality of light modules is illuminated with a ramping light pattern.

10. The lighting system of claim 6, wherein a first corner module and a second corner module are included in the first light sequence, the second light sequence, or a combination thereof.

11. The lighting system of claim 6, wherein the boot-up sequence further comprises:
one or more flashes of a corner color emitted by a first corner module and a second corner module.

12. The lighting system of claim 11, wherein the one or more flashes of the first corner light module and the second corner light module occur substantially simultaneously.

13. The lighting system of claim 1, further comprising:
an ambient light sensor; and
an analysis module configured to:
receive an ambient light measurement from the ambient light sensor;
receive a module light measurement at least a portion of the plurality of light modules;
calculate a light output of the at least a portion of the plurality of light modules based on the ambient light measurement and the module light measurement; and
determine if the light output complies with National Fire Protection Association (NFPA) requirements.

14. A method of testing the operation of the emergency lighting system of claim 1, comprising:
supplying power to an emergency light bar of the emergency lighting system; and
executing a boot-up light sequence.

15. The method of claim 14, wherein executing the boot-up light sequence comprises:
flashing the first corner module and the second corner modules with a corner color;
illuminating the first corner module, the second corner module, and the plurality of light modules towards a central line of the emergency light bar with a first color; and
illuminating the first corner module, the second corner module, and the plurality of light modules away from the central line of the emergency light bar with a second color.

16. The method of claim 15, wherein illuminating the first corner module, the second corner module, and the plurality of light modules comprises:
fading each light module in; and
fading each light module out.

17. The method of claim 15, wherein flashing the first corner module and the second corner module comprises flashing the first corner module and the second module twice, substantially simultaneously.

18. A method of determining an operability of the lighting system of claim 1, the method comprising activating a pre-trip inspection mode, wherein the pre-trip inspection mode comprises:
illuminating one or more light modules of the plurality of light modules in a walk-around path sequence;
calculating a light output of the one or more light modules;
determining if the light output complies with a lighting threshold; and
issuing an alert when the light output does not comply with the lighting threshold.

19. The method of claim 18, wherein the lighting threshold is based on National Fire Protection Association (NFPA) standards.

20. The method of claim 18, wherein the method further comprises:
engaging a safety interlock when the light output does not comply with the lighting threshold.
